(19) United States
(12) Patent Application Publication
(10) Pub. No.: US 2004/0173190 A1
(43) Pub. Date: Sep. 9, 2004

(54) Evaporated fuel treating device

(75) Inventor: Katsuhiko Makino, Obu (JP)

Correspondence Address: STEVENS DAVIS MILLER & MOSHER, LLP, 1615 L STREET, NW, SUITE 850, WASHINGTON, DC, 20036, US

(73) Assignee: AISAN KOGYO KABUSHIKI KAISHA, Aichi-ken (JP)

(21) Appl. No.: 10/784,236

(22) Filed: Feb. 24, 2004

(30) Foreign Application Priority Data
Mar. 4, 2003 (JP) 2003-056634

(51) Int. Cl. F02M 25/08

(52) U.S. Cl. 123/520

(57) ABSTRACT

In an evaporated fuel treating device in which evaporated fuel from a fuel tank is guided into a main canister and a sub-canister in series, in order to reduce the amount of evaporated fuel remaining in the sub-canister after a purge and the amount of evaporated fuel discharged from the sub-canister while evaporated fuel is being adsorbed, a purge passage for the main canister and an open air port for the main canister are provided, a purge passage for the sub-canister and an open air port for the sub-canister are further provided, and a valve unit is provided on a communicating path between the main canister and the sub-canister. At the time of purging, the valve unit lets air from the open air port for the main canister flow into the purge passage for the main canister through the main canister and air from the open air port for the sub-canister flow through the sub-canister into the purge passage for the sub-canister.

### FIELD OF THE INVENTION

The present invention relates to an evaporated fuel treating device.

### DESCRIPTION OF THE RELATED ART

In order to prevent evaporated fuel generating in the fuel tank of a motor vehicle, for instance, from being discharged into the atmosphere, evaporated fuel treating devices are generally known, which catch evaporated fuel having generated in the fuel tank while the engine is at a halt into a canister provided with an adsorbent, such as activated carbon, by its adsorptive effect, and purge the adsorbed and collected evaporated fuel into the intake pipe of the engine when it is at work.

In one of such known evaporated fuel treating devices, a main canister 103 and a sub-canister 104 are connected in series to the upper air space of a fuel tank 101 via an evaporated fuel passage 102 as shown in FIG. 8, and a throttle 105 is provided on a communication path between the main canister 103 and the sub-canister 104. When the engine 106 is at a halt, evaporated fuel having generated in the upper air space of the fuel tank 101 is collected into the main canister 103 and the sub-canister 104 by adsorption, and when the engine 106 is at work, the evaporated fuel collected by the main canister 103 and the sub-canister 104 is purged together with air sucked through an open air port 109 by opening a purge valve 107 and utilizing the negative pressure of the intake pipe 108. Such a configuration is disclosed in JP-A-6-74107, for example.

Also in another known evaporated fuel treating device, as shown in FIG. 9, a plurality of divided layers 202 connected in series are provided in a casing 201, and a purge valve 203 and an open air valve 204 are arranged in each of the divided layers 202. When the engine is at a halt, both valves 203 and 204 are closed to guide the evaporated fuel in a fuel tank 205 into the divided layers 202 in series and to adsorb the fuel vapor, and when the engine is at work, both valves 203 and 204 are opened to shorten the path length of each of the divided layers 202 and cause the evaporated fuel from the plurality of divided layers 202 to be purged into an intake pipe 207 through a single purge control 206. Such a device is disclosed in JP-A-7-12018, for example.

In the evaporated fuel treating device of JP-A-6-74107 illustrated in FIG. 8 wherein the main canister 103 and the sub-canister 104 are arranged in series, the latter closer to the open air port 109, the amount of evaporated fuel discharged through the open air port 109 decreases as that of evaporated fuel remaining in the sub-canister 104 after the purge becomes smaller.

Therefore, it is necessary to cause more of the evaporated fuel in the sub-canister 104 to be purged by increasing the purge air amount at the time of purge, but this would entail an increase in the amount of purge air needed for purging the evaporated fuel in the main canister 103 as well, and the amount of evaporated fuel (vapor amount) supplied from within the main canister 103 to the intake pipe 108 will inevitably increase, too. Then, the gas purged in the early phase of engine start-up will become richer in fuel, and the air/fuel (A/F) ratio will fall below its setpoint to adversely affect the performance of the engine.

Also, with only the remaining amount of evaporated fuel in the main canister 103 being taken into consideration, if the air flow from the open air port 109 is reduced by tightening the throttle 105 when a large amount of evaporated fuel is remaining in the main canister 103, a purged amount of the evaporated fuel in the sub-canister 104 will decrease to cause a large amount of evaporated fuel to remain in the sub-canister 104, which might invite discharging of the evaporated fuel in the sub-canister 104 into the atmosphere.

In the evaporated fuel treating device of JP-A-7-12018 illustrated in FIG. 9, though the path length of each divided layer 202 is shortened at the time of purge and the resistance to air flow decreases as a result, purge cannot be accomplished in a large volume as only one purge control valve 206 is provided and accordingly, when a large quantity of evaporated fuel is remaining in the canister, the evaporated fuel cannot be purged at a high flow rate. As a consequence, a large amount of evaporated fuel will remain, some of which might be discharged into the atmosphere.

### BRIEF SUMMARY OF THE INVENTION

An object of the present invention is to provide an evaporated fuel treating device which can prevent the air/fuel (A/F) ratio at the time of purge from becoming over-rich, keep the remaining amount of evaporated fuel in a sub-canister arranged closer to the open air side to the minimum, and prevent the evaporated fuel from being discharged into the atmosphere.

In order to achieve the object stated above, in an evaporated fuel treating device according to a first aspect of the invention in which evaporated fuel from a fuel tank is guided in series into a main canister and a sub-canister, the purge passage of the main canister and that of the sub-canister used at the time of purge are separately formed.

In an evaporated fuel treating device according to a second aspect of the invention in which evaporated fuel from a fuel tank is guided in series into a main canister and a sub-canister, at the time of purge, air is guided from an open air port for the main canister to an intake pipe through the main canister, and air sucked through another open air port provided in the sub-canister is let flow through the sub-canister, without allowing it to pass the main canister, and guided to the intake pipe.

In an evaporated fuel treating device according to a third aspect of the invention in which evaporated fuel from a fuel tank is guided in series into a main canister and a sub-canister, a purge passage for the main canister and an open air port for the main canister are provided, a purge passage for the sub-canister and an open air port for the sub-canister are further provided, a valve unit is provided on a communication path between the main canister and the sub-canister and, at the time of purge, the valve unit lets air from the open air port for the main canister to flow into the purge passage for the main canister through the main canister while letting air from the open air port for the sub-canister flow to the purge passage for the sub-canister through the sub-canister.

An evaporated fuel treating device according to a fourth aspect of the invention comprises a passage for guiding evaporated fuel from a fuel tank into a main canister, a communication path for establishing communication between the main canister and a sub-canister, a valve unit provided on the communication path between the main canister and the sub-canister, an open air port for the main canister provided in the valve unit, an open air port provided in the sub-canister, a first purge passage provided in the main canister, a second purge passage provided in the sub-canister, a first purge valve provided in the first purge passage, and a second purge valve provided in the second purge passage, wherein both of the purge valves are closed and the valve unit is operated so as to establish communication between the main canister and the sub-canister at the time of adsorbing the evaporated fuel and, at the time of purge, both of the purge valves are opened and the valve unit is controlled so as to intercept the communication path between the main canister and the sub-canister, guide air from the open air port for the main canister into the main canister and let the air guided from the open air port of the sub-canister pass the sub-canister so as to guide it to the intake pipe via the second purge passage.

In the third or fourth aspect, the valve unit may as well be operated by a positive pressure working in the main canister and a negative pressure working the intake pipe.

Further, in the third or fourth aspect, the valve unit may be a change-over valve to be controlled by an electronic control unit.

With the configurations described above, when the engine is at a halt, evaporated fuel generating in the fuel tank flows through the main canister and then flows into the sub-canister, and is adsorbed by adsorbents in the two canisters and thereby collected.

When the engine is operated, air (atmosphere) is sucked into the purge passage of the main canister and another purge passage, that belongs to the sub-canister, to perform purging.

Since another independent purging process then takes place in the sub-canister, unaffected by the remaining level of evaporated fuel in the main canister, the amount of purge air in the sub-canister can be increased.

In the sub-canister whose adsorbent capacity is smaller than that of the main canister, the remaining amount of evaporated fuel in the adsorbent state is smaller.

As a result, it is possible to minimize the remaining amount of evaporated fuel after the purge of evaporated fuel in the sub-canister, and thereby to substantially reduce the amount of evaporated fuel discharged from the sub-canister into the atmosphere during the subsequent adsorption of evaporated fuel.

Moreover, the large amount of purge air serves to reduce the length of time taken by the purge in the sub-canister.

Furthermore, since only a small amount of evaporated fuel remains in the sub-canister in the adsorbent state, purging with even a large amount of air (atmosphere) little affects the air/fuel (A/F) ratio.

### BRIEF DESCRIPTION OF THE SEVERAL VIEWS OF THE DRAWINGS

FIG. 1 is a system diagram of an evaporated fuel treating device, which is a first preferred embodiment according to the present invention.

FIG. 2 illustrates how evaporated fuel is adsorbed in the device of FIG. 1.

FIG. 3 illustrates how purging takes place in the device of FIG. 1.

FIGS. 4A and 4B are views showing comparison of the device according to the invention with a conventional device in terms of the experimental amounts of vapor discharge.

FIG. 5 illustrates a method of evaluating the experiment shown in FIGS. 4A and 4B.

FIG. 6 is a system diagram of an evaporated fuel treating device, which is a second preferred embodiment according to the invention.

FIG. 7 shows a sectional profile of the canister unit in a third preferred embodiment according to the invention.

FIG. 8 is a system diagram of a first conventional device.

FIG. 9 is a system diagram of a second conventional device.

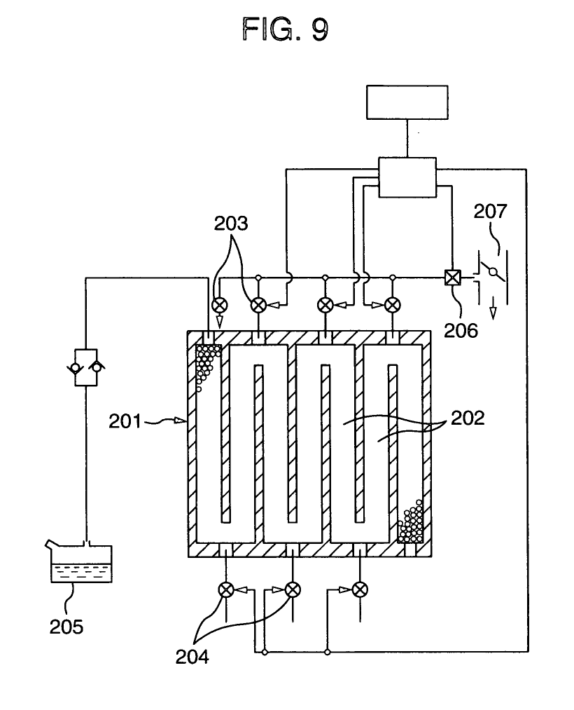

### DETAILED DESCRIPTION OF THE INVENTION

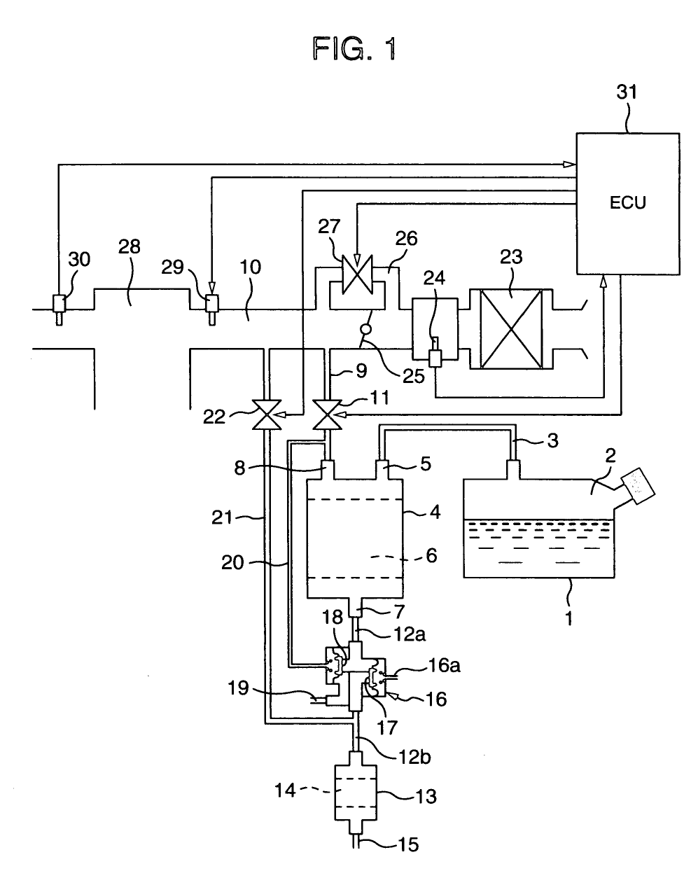

Preferred modes of implementing the present invention will be described below with reference to embodiments thereof illustrated in FIG. 1 through FIG. 7.

FIG. 1 through FIG. 5 show a first embodiment according to the invention.

Referring to FIG. 1, which is a system diagram, an upper air space 2 of a fuel tank 1 mounted on a motor vehicle or the like communicates with a tank port 5 of a main canister 4 through an evaporated fuel passage 3, and evaporated fuel (vapor) in the fuel tank 1 flows into the main canister 4.

In the main canister 4 is provided an adsorbent layer (adsorbent) 6 consisting of an adsorbent, such as activated charcoal, and toward one end of the adsorbent layer 6 is arranged the tank port 5 while an open air port 7 is arranged toward the other end. On the other side from the open air port 7 is arranged a purge port 8. Evaporated fuel having flowed into the tank port 5 is adsorbed and collected by the adsorbent layer 6 and, at the time of purge, a negative pressure of the intake pipe working on the purge port 8 enables air flowing from the open air port 7 to the purge port 8 to purge the evaporated fuel adsorbed and collected by the adsorbent layer 6 from the purge port 8 to an intake pipe 10.

Communication of the purge port 8 with the intake pipe 10 is established by a first purge passage 9, and the first purge passage 9 is provided with a first purge valve 11 to open and close it.

A sub-canister 13 is arranged, enabled to communicate with the open air port 7 of the main canister 4 by a first communication path 12a and a second communication path 12b. In the sub-canister 13 is provided an adsorbent layer (adsorbent) 14, and toward one end of the adsorbent layer 14 is provided the second communication path 12b while an the open air port 15 is provided toward the other end.

The adsorbent capacity of the main canister 4 is, not unexpectedly, greater than that of the sub-canister 13, and the range of adsorbent capacity for practical use is 1.8 to 3.0 liters for the former and 0.03 to 0.3 liters for the latter.

Between the first and second communication paths 12a and 12b is provided a valve unit 16, and the valve unit 16 comprises a positive pressure valve 17 and a negative pressure valve 18. Behind the positive pressure valve 17, atmosphere from an open air port 16a works and, when the pressure on the first communication path 12a side (positive pressure) becomes higher than the atmospheric pressure, the resultant differential pressure opens the positive pressure valve 17 against a spring pressure to establish communication between the two communication paths 12a and 12b. When the pressure on the first communication path 12a side becomes equal to or lower than the atmospheric pressure, the positive pressure valve 17 is closed by the atmospheric pressure and the spring pressure to intercept communication between the communication paths 12a and 12b.

Behind the negative pressure valve 18, a bypass 20 bypasses the main canister 4 and establishes communication with the first purge passage 9 between the main canister 4 and the first purge valve 11, and the other side from that back side communicates with an open air port 19. When the pressure in the negative pressure valve 18 on the bypass 20 side becomes negative, the resultant difference from the atmospheric pressure causes the negative pressure valve 18 to open to establish communication between the open air port 19 and the first communication path 12a. When the pressure on the bypass 20 side becomes equal to or higher than the atmospheric pressure, the spring pressure causes the valve to be closed to intercept communication between the open air port 19 and the first communication path 12a.

A second purge passage 21 branches into the second communication path 12b which establishes communication between the valve unit 16 and the sub-canister 13, and its other end communicates with the intake pipe 10. Further, the second purge passage 21 is provided with a second purge valve 22, which opens and closes it.

At the upstream end of the intake pipe 10 is arranged an air cleaner 23; downstream from the air cleaner 23 is arranged an air flowmeter 24 for detecting the amount of air sucked into the intake pipe 10; downstream from it is arranged a throttle valve 25; and downstream from the throttle valve 25 the first purge passage 9 and the second purge passage 21 open. Farther downstream from the air flowmeter 24 is provided a passage 26 for bypassing the throttle valve 25, and the passage 26 is provided with an air control valve (ACV) 27.

Further, the downstream side of the intake pipe 10 communicates with the engine 28, and in the vicinities of the engine 28 are arranged an injector 29 and an O₂ sensor 30.

Incidentally, the first purge valve 11, the second purge valve 22, the air flowmeter 24, the ACV 27, the injector 29 and the O₂ sensor 30 are controlled by an electronic control unit (ECU) 31.

Next will be described the actions of the device.

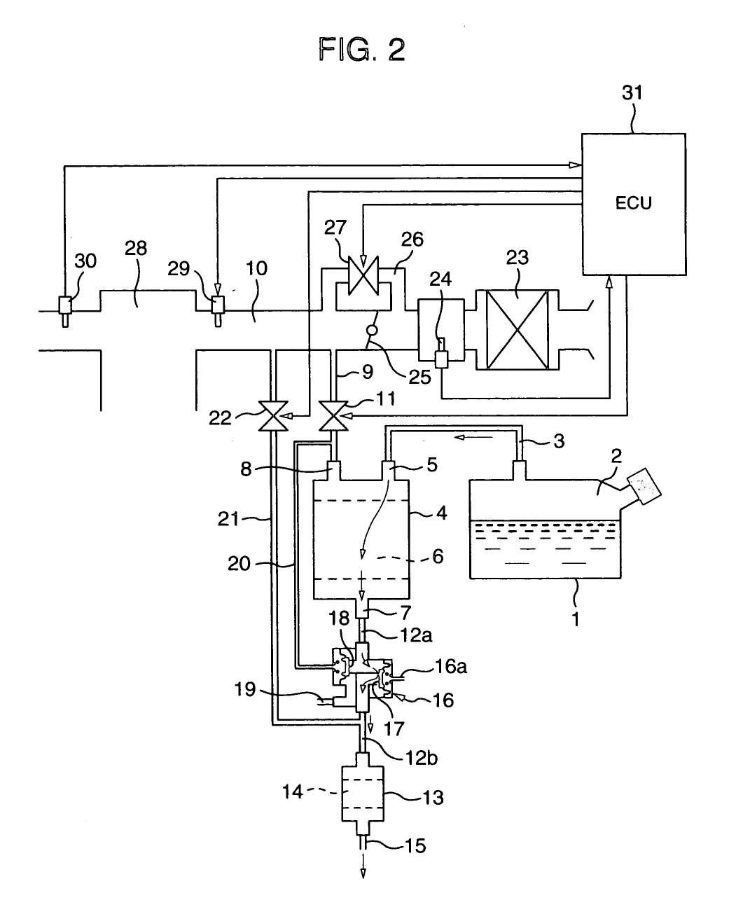

When the engine 28 is at a halt, both the first purge valve 11 and the second purge valve 22 are kept close by the ECU 31. In this state, evaporated fuel having generated in the upper air space 2 of the fuel tank 1 passes through the evaporated fuel passage 3 and flows from the tank port 5 of the main canister 4 in the adsorbent layer 6 within the main canister 4, as indicated by arrows in FIG. 2. Further, the evaporated fuel passes through the open air port 7 and the first communication path 12a, and acts on a surface of the positive pressure valve 17 opposite to the open air port 16a in the valve unit 16. Then, if the pressure of gas containing the evaporated fuel becomes higher than the total of the atmospheric pressure and the spring pressure, the positive pressure valve 17 will be opened. This opening of the valve causes the evaporated fuel to flow through the positive pressure valve 17 into the sub-canister 13, as indicated by another arrow in FIG. 2. Therefore, the evaporated fuel is adsorbed and collected by the adsorbents 6 and 14 of the main canister 4 and the sub-canister 13, respectively. In this case, as the amount of the adsorbent in the sub-canister 13 is far smaller than that of the adsorbent in the main canister 4 and evaporated fuel not adsorbed by the main canister 4 flows into the sub-canister 13, the amount of evaporated fuel adsorbed and collected by the sub-canister 13 is far smaller than that by the main canister 4.

Incidentally, as the first purge valve 11 and the second purge valve 22 are closed, the evaporated fuel does not flow into the intake pipe 10. As the pressure of gas containing the evaporated fuel acts on the back side of the negative pressure valve 18, the negative pressure valve 18 is in a closed state.

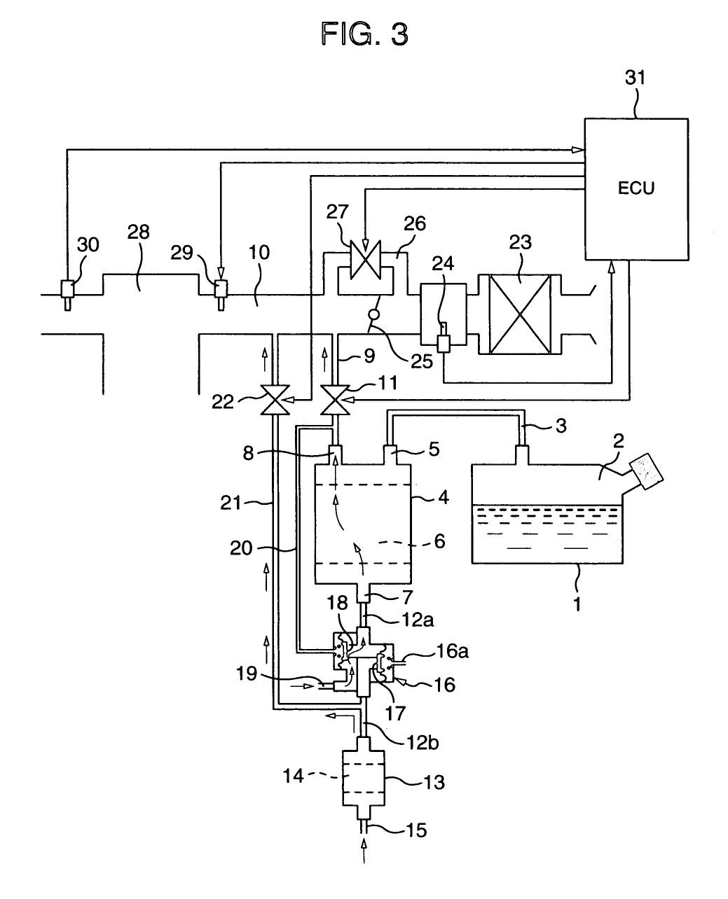

Then, when the engine is started, the ECU 31 causes both the first purge valve 11 and the second purge valve 22 to open. This opening of the first purge valve 11 causes the negative pressure in the intake pipe 10 to work on the back side of the negative pressure valve 18 in the valve unit 16 through the first purge passage 9 and the bypass 20 and, as atmosphere from the open air port 19 works on the other side of the negative pressure valve 18 opposite to that back side, a differential pressure causes the negative pressure valve 18 to open against the spring pressure. This opening of the negative pressure valve 18 causes air to flow in from the open air port 19. This air, as indicated by arrows in FIG. 3, passes the negative pressure valve 18, flows into the main canister 4, and further flows from the purge port 8 into the intake pipe 10 via the first purge passage 9 and the first purge valve 11. This flow of air causes the evaporated fuel adsorbed and collected in the main canister 4 to be separated from the adsorbent 6 and purged into the intake pipe 10 together with the air.

The opening of the second purge valve 22 causes the negative pressure in the intake pipe 10 to act on the sub-canister 13 by way of the second purge passage 21. This negative pressure also works on the face on the other side from the open air port 16a in the positive pressure valve 17, and the difference between this negative pressure and the atmospheric pressure causes the positive pressure valve 17 to close. Therefore, as indicated by arrows in FIG. 3, air is guided in through the open air port 15 of the sub-canister 13. This air passes the sub-canister 13, and flows into the intake pipe 10 via the second purge passage 21 and the second purge valve 22. This flow of air causes the evaporated fuel adsorbed and collected in the sub-canister 13 to be separated from the adsorbent 14 and purged into the intake pipe 10 together with the air.

Therefore, the purge passage of the main canister 4 and that of the sub-canister 13 are independent of each other, and the purge of the evaporated fuel in the sub-canister 13 is accomplished via the purge passage of its own, separately from purging in the purge passage of the main canister 4. In other words, it independently takes place unaffected by the remaining amount of evaporated fuel adsorbed by the adsorbent 6 in the main canister 4.

Furthermore, since the adsorbent capacity of the sub-canister 13 is smaller than that of the main canister 4, the remaining amount of evaporated fuel adsorbed and collected in the sub-canister 13 is smaller.

As a result, once the purging is started, the evaporated fuel remaining in the sub-canister 13 is early purged by a large amount of air (fresh air), and the remaining amount of evaporated fuel in the sub-canister 13 after the stop of the engine can be substantially reduced in comparison with the conventional arrangement.

That the remaining amount of evaporated fuel in the sub-canister 13, which is the closest to the side open to the atmosphere, can be reduced substantially (close to a completely purged state) means that, when evaporated fuel from the fuel tank 1 during the next inactive state of the engine is to be adsorbed, the efficiency of catching the evaporated fuel having passed the main canister 4 by the sub-canister 13 is enhanced, resulting in a significant reduction in the discharge of evaporated fuel into the atmosphere.

Moreover, even if evaporated fuel in the sub-canister 13 is purged by letting a large amount of air pass the sub-canister 13 during the above purge process, the mixture gas in the intake pipe 10 will not become over-rich because the remaining amount of evaporated fuel in the sub-canister 13 is far smaller than that in the main canister 4.

To add, air guided in through the first purge passage 9 and the second purge passage 21 while the engine is at work is handled in the following way.

In principle, since the air amount Q1 passing the first purge valve 11 of the first purge passage 9 and the air amount Q2 passing the second purge valve 22 of the second purge passage 21 are considerably smaller than the air amount Q3 passing the air flowmeter 24 (Q3>>Q1, Q3>>Q2), any increase or decrease in Q1 and Q2 does not significantly affect the set amount of air intake.

However, when the amount of air intake into the engine is to be adjusted relative to these air amounts Q1 and Q2, the adjustment shall be accomplished in the following manner.

The air intake amount Q_{T} into the engine is the total of Q1, Q2 and Q3. These air flow rates depending on the opening or closing of the first purge valve 11 and the second purge valve 22 and the air flow rate in the air flowmeter 24 can be computed by the ECU 31 which receives signals from these constituent elements.

Therefore, when the air amount Q_{T} passing the intake pipe 10 has surpassed its setpoint owing to the opening of the first and second purge valves 11 and 22, the ACV 27 is tightened at the instruction of the ECU 31 to reduce that flow rate and thus, to adjust the air amount Q_{T} passing the intake pipe 10 to its setpoint.

If the system configuration uses an electronic throttle, the ACV 27 will be unnecessary.

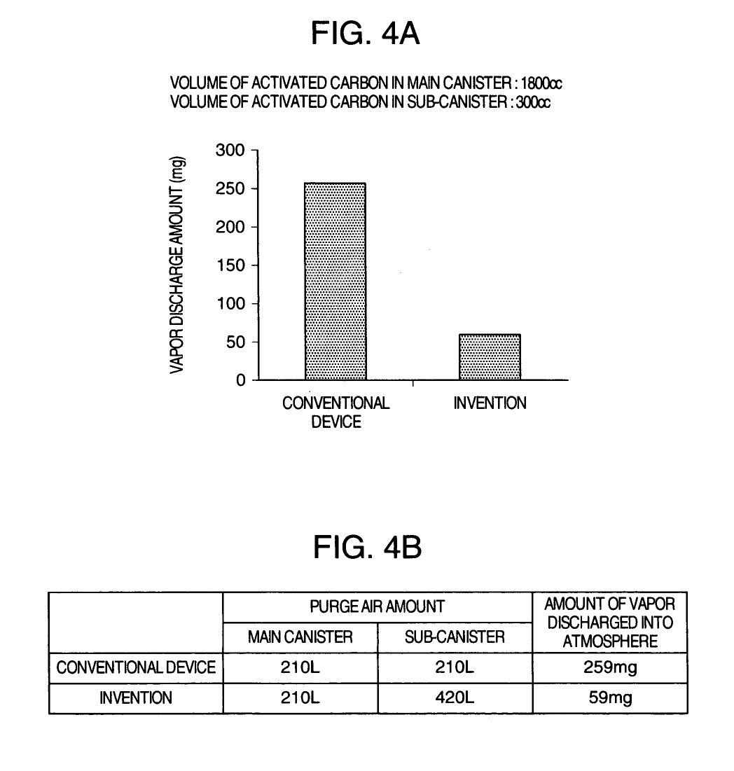

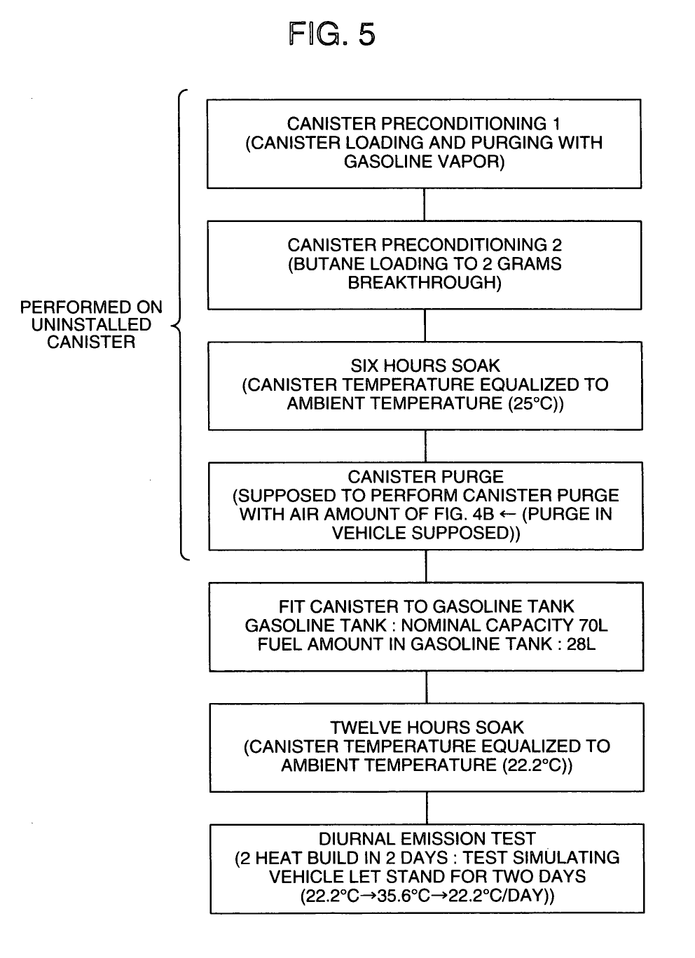

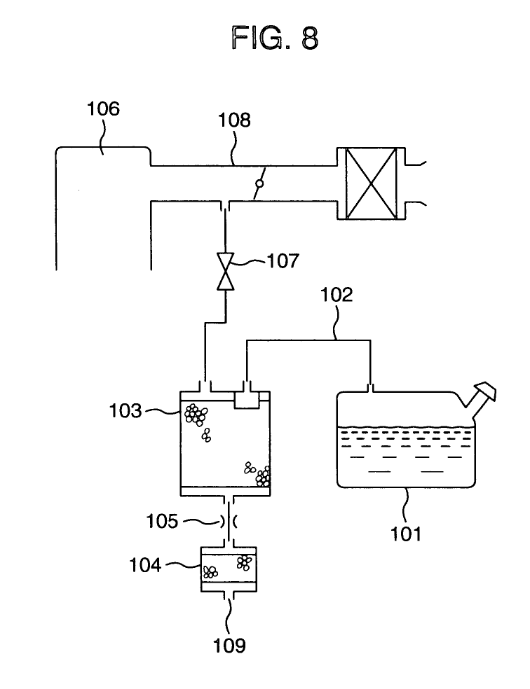

Next will be explained with reference to FIGS. 4A and 4B and FIG. 5 the results of a comparative experiment in terms of vapor discharge amount of the evaporated fuel treating device which embodies the present invention and the conventional evaporated fuel treating device illustrates in FIG. 8.

In both devices, the volume of activated carbon in the main canister was 1800 cc and that in the sub-canister was 300 cc. The method of evaluation is illustrated in FIG. 5.

At the time of purging, as shown in FIG. 4B, the amount of purge air passing the conventional main canister was 210 liters. As the same amount of purge air as that passing the main canister flows to the sub-canister in this case, 210 liters of purge air also flows to the sub-canister.

The same 210 liters of purge air was let pass the main canister according to the invention. As the purge air amount flowing to the sub-canister can be set independent of that to the main canister, the purge air amount for this sub-canister was set to 420 liters.

As a result, the purge air amount passing the sub-canister according to the invention was found greater than in the conventional device, and the amount of evaporated fuel remaining in the sub-canister decreased, and the vapor discharge amount was 59 mg from the device according to the invention against 259 mg from the conventional one as shown in FIGS. 4A and 4B. These discharge amounts are daily totals on the second day in the “diurnal emission test” of FIG. 5.

Therefore, the present invention has proved highly efficient in restraining the emission of vapor into the atmosphere.

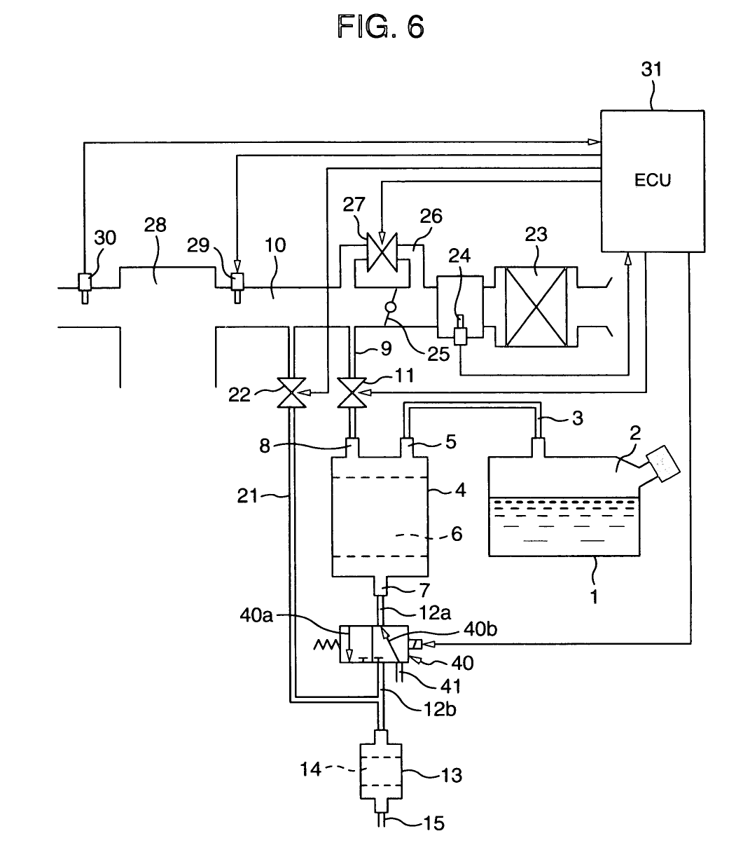

FIG. 6 shows a second preferred embodiment according to the invention.

This second preferred embodiment replaces the valve unit 16 in the first embodiment with a change-over valve 40 and the bypass 20 in the first embodiment is absent here.

Since other structural features are the same as those of the first embodiment, the same constituent elements as in the first embodiment will be denoted by respectively the same reference signs, and their description will be dispensed with.

The switching of the change-over valve 40 in the second embodiment is controlled by the ECU 31. When the engine is at a halt, the change-over valve 40 shifts rightward from the state shown in FIG. 6, establishing communication between the first communication path 12a and the second communication path 12b with a passage 40a of the change-over valve and intercepting communication between the first communication path 12a and an open air port 41. During a purging process by the operation of the engine, the change-over valve 40 takes on the state shown in FIG. 6, and a passage 40b thereof establishes communication between the first communication path 12a and the open air port 41 while intercepting communication between the first communication path 12a and the second communication path 12b.

In this second embodiment, when the engine is at a halt, by keeping both purge valves 11 and 22 closed to place the change-over valve 40 in the aforementioned state, evaporated fuel having generated in the fuel tank 1 is caused to flow into the main canister 4 and after that into the sub-canister 13 via the first communication path 12a, the passage 40a of the change-over valve 40 and the second communication path 12b, and is adsorbed and collected by the adsorbent 6 of the main canister 4 and the adsorbent 14 of the sub-canister 13.

At the time of purging, by keeping both purge valves 11 and 22 open to switch the change-over valve 40 into the state shown in FIG. 6, air is caused to be sucked through the open air port 41 to pass the main canister 4 via the passage 40b of the change-over valve 40 and the first communication path 12a and sucked through the purge port 8 into the intake pipe 10 via the first purge passage 9, and the evaporated fuel adsorbed and collected by the adsorbent 6 of the main canister 4 is purged into the intake pipe 10.

The evaporated fuel adsorbed and collected by the adsorbent 14 of the sub-canister 13 is purged by air sucked through the open air port 15 of the sub-canister 13, passing the sub-canister 13, and further sucked into the intake pipe 10 via the second communication path 12b and the second purge passage 21.

Therefore, also in this second embodiment, at the time of purging, evaporated fuel collected in the sub-canister 13 is purged, separately and independently from the main canister 4, through its own purge passage separate from that of the main canister 4, making it possible to achieve the same effect as does the first embodiment.

Furthermore, as the bypass 20 can be dispensed with, the piping of the apparatus can be simplified.

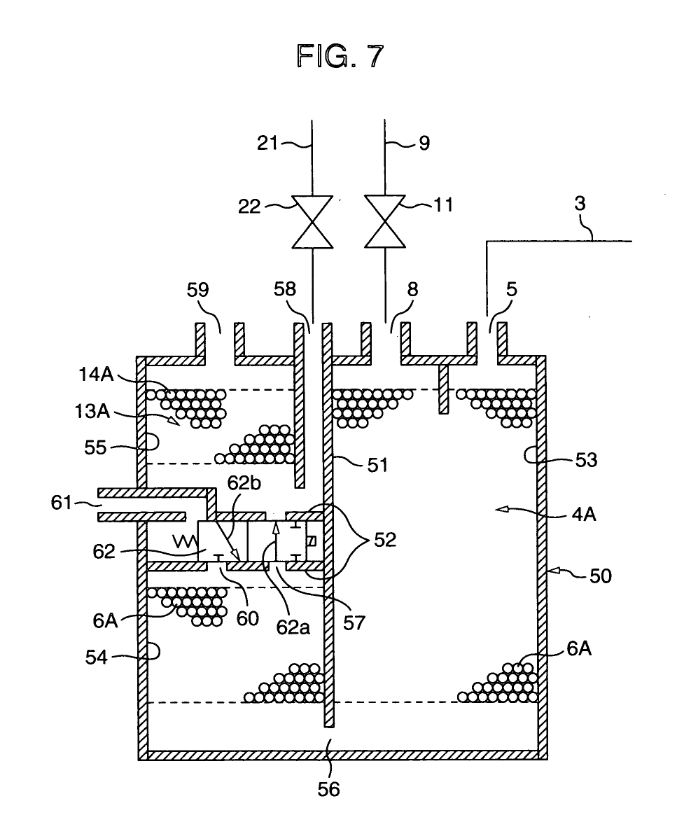

FIG. 7 shows a third preferred embodiment according to the present invention.

This third embodiment is an example of application to a U-shaped flow type canister in which a main canister and a sub-canister are arranged in a single case.

The inside of a canister case 50 is partitioned by a first partition wall 51 and a second partition wall 52 into a first chamber 53, a second chamber 54 and a third chamber 55, the first chamber 53 and the second chamber 54 communicate with each other via a communication chamber 56, the second chamber 54 and the third chamber 55 are formed to be made communicable between each other by a first communication path 57 formed in the second partition wall 52, and these chambers communicate with one another in series. The first chamber 53 and the second chamber 54 constitute a main canister 4A, and the third chamber 55 constitutes a sub-canister 13A. Further, these chambers are filled with adsorbents 6A and 14A consisting of activated carbon or the like.

In the first chamber (main canister) 53 are provided the tank port 5 to the fuel tank 1 and the purge port 8 to the first purge passage 9, similar to their respective counterparts in the first embodiment. Reference numeral 11 denotes a first purge valve similar to the aforementioned.

In the third chamber (sub-canister) 55 is provided a purge port 58 to the second purge passage 21 similar to its counterpart in the first embodiment. Reference numeral 22 denotes a second purge valve similar to its counterpart in the first embodiment. Further, in the third chamber (sub-canister) 55 is provided an open air port 59 for the sub-canister.

The second partition wall 52 is provided with a second communication port 60 opening to the second chamber 54 and an open air port 61 for the main canister.

Further the second partition wall 52 is provided with a change-over valve (valve unit) 62 controlled by the ECU 31 in the first embodiment. When the engine is at a halt, the change-over valve 62 is in the state shown in FIG. 7, and its passage 62a establishes communication between the second chamber 54 (main canister) and the third chamber 55 (sub-canister), and intercepts communication between the second chamber 54 and the open air port 61. When the engine is at work to perform purging, the change-over valve 62 shifts leftward from the state shown in FIG. 7, and its passage 62b establishes communication between the open air port 61 and the second chamber 54 (main canister) and intercepts communication between the second chamber 54 (main canister) and the third chamber 55 (sub-canister).

The other structural features are the same as in the first embodiment.

In this third embodiment, when the engine is at a halt, by keeping both purge valves 11 and 22 closed to place the change-over valve 62 in the state shown in FIG. 7, evaporated fuel having generated in the fuel tank is caused to flow into the main canister 4A consisting of the first chamber 53 and the second chamber 54 and after that into the sub-canister 13A consisting of the third chamber 55 via the first communication path 57 and the passage 62a of the change-over valve 62, and is adsorbed and collected by the adsorbent 6A of the main canister 4A and the adsorbent 14A of the sub-canister 13A.

At the time of purging, by keeping both purge valves 11 and 22 open to switch the change-over valve 62 by shifting it leftward from the stage shown in FIG. 7, air is caused to be sucked through the open air port 61 for the main canister, flows through the passage 62b of the change-over valve 62 into the second chamber 54, and further passes the communication chamber 56 and the first chamber 53 to be sucked through the purge port 8 into the intake pipe 10 via the first purge passage 9. The evaporated fuel adsorbed and collected by the adsorbent 6A of the main canister 4A is purged into the intake pipe 10.

The evaporated fuel adsorbed and collected by the adsorbent 14A in the second chamber 55 constituting the sub-canister 13A is purged by air sucked through the open air port 59 of the sub-canister 13A, passing the sub-canister 13A constituted by the second chamber 55, and further sucked through the purge port 58 into the intake pipe 10 via the second purge passage 21.

Therefore, also in this third embodiment, at the time of purging, the evaporated fuel adsorbed and collected in the sub-canister 13A is purged, separately and independently from the main canister, through its own purge passage separate from that of the main canister 4A, making it possible to achieve the same effect as does the first embodiment.

Furthermore, since almost the whole piping is accommodated in the canister case 50, the piping can be simplified even more than in the first and second embodiments, and at the same time the evaporated fuel treating device can be made more compact.

As hitherto described, since the present invention makes it possible to purge remaining evaporated fuel adsorbed by the adsorbent which is in the closest position to the side open to the atmosphere (in the sub-canister) with a large amount of purge air, the amount of evaporated fuel remaining in the sub-canister after the purge can be minimized. As a result, when evaporated fuel is being adsorbed during an inactive period of the engine, the efficiency of adsorption and collection of evaporated fuel by the sub-canister having passed the main canister can be enhanced and the amount of evaporated fuel discharged into the atmosphere can be reduced.

What is claimed is:

1. An evaporated fuel treating device in which evaporated fuel from a fuel tank is guided in series into a main canister and a sub-canister, wherein the purge passage of the main canister and that of the sub-canister used at the time of purge are separately formed.

2. An evaporated fuel treating device in which evaporated fuel from a fuel tank is guided in series into a main canister and a sub-canister, wherein, at the time of purge, air is guided from an open air port for the main canister to an intake pipe through the main canister, and air sucked through another open air port provided in the sub-canister is let flow through the sub-canister, without allowing it to pass the main canister, and guided to the intake pipe.

3. An evaporated fuel treating device in which evaporated fuel from a fuel tank is guided in series into a main canister and a sub-canister, wherein a purge passage for the main canister and an open air port for the main canister are provided, a purge passage for the sub-canister and an open air port for the sub-canister are further provided, a valve unit is provided on a communicating path between the main canister and the sub-canister and, at the time of purge, said valve unit lets air from the open air port for the main canister to flow into the purge passage for the main canister through the main canister, while letting air from the open air port for the sub-canister flow to the purge passage for the sub-canister through the sub-canister.

4. An evaporated fuel treating device comprising a passage for guiding evaporated fuel from a fuel tank into a main canister, a communicating path for establishing communication between the main canister and a sub-canister, a valve unit provided on the communicating path between the main canister and the sub-canister, an open air port for the main canister provided in the valve unit, an open air port provided in the sub-canister, a first purge passage provided in the main canister, a second purge passage provided in the sub-canister, a first purge valve provided in said first purge passage, and a second purge valve provided in said second purge passage, wherein both of said purge valves are closed and the valve unit is operated so as to establish communication between the main canister and the sub-canister at the time of adsorbing the evaporated fuel and, at the time of purge, both of said purge valves are opened and the valve unit is controlled so as to intercept said communicating path between the main canister and the sub-canister, guide air from the open air port for the main canister into the main canister and let air guided from the open air port of the sub-canister pass the sub-canister so as to guide it to the intake pipe via said second purge passage.

5. An evaporated fuel treating device according to claim 3, wherein said valve unit is operated by a positive pressure working in the main canister and a negative pressure working the intake pipe.

6. An evaporated fuel treating device according to claim 4, wherein said valve unit is operated by a positive pressure working in the main canister and a negative pressure working the intake pipe.

7. An evaporated fuel treating device according to claim 3, wherein said valve unit is a change-over valve and the change-over valve is controlled by electronic control means.

8. An evaporated fuel treating device according to claim 4, wherein said valve unit is a change-over valve and the change-over valve is controlled by electronic control means.
